(19) United States
(12) Patent Application Publication
(10) Pub. No.: US 2013/0311476 A1
(43) Pub. Date: Nov. 21, 2013

(54) METHOD AND APPARATUS FOR ON-THE-FLY CATEGORIZATION AND OPTIONAL DETAILS EXTRACTION FROM QUESTIONS POSTED TO AN ONLINE CONSULTATION SYSTEM

(71) Applicant: Pearl.com LLC, San Francisco, CA (US)

(72) Inventor: Gann Bierner, Oakland, CA (US)

(73) Assignee: Pearl.com LLC, San Francisco, CA (US)

(21) Appl. No.: 13/946,986

(22) Filed: Jul. 19, 2013

Related U.S. Application Data
(63) Continuation-in-part of application No. 12/854,846, filed on Aug. 11, 2010.
Application No. 12/854,846 is a continuation-in-part of application No. 12/854,838, filed on Aug. 11, 2010.
Application No. 12/854,838 is a continuation-in-part of application No. 13/439,743, filed on Apr. 4, 2012.
Application No. 13/439,743 is a continuation of application No. 12/854,849, filed on Aug. 11, 2010, now abandoned.
Application No. 12/854,849 is a continuation-in-part of application No. 13/464,269, filed on May 4, 2012.
(60) Provisional application No. 61/233,046, filed on Aug. 11, 2009.
(60) Provisional application No. 61/233,046, filed on Aug. 11, 2009.
(60) Provisional application No. 61/233,046, filed on Aug. 11, 2009.

(51) Int. Cl. G06F 17/30

(52) U.S. Cl. CPC G06F 17/30598
USPC 707/740

(57) ABSTRACT

Embodiments of the present invention further provide systems and methods for automatically categorizing and extracting details in real-time from questions submitted by users to an online consultation system.

### RELATED APPLICATIONS

The present application is a Continuation-in-Part of U.S. patent application Ser. No. 12/854,846 filed on Aug. 11, 2010; U.S. patent application Ser. No. 12/854,838 filed on Aug. 11, 2010; U.S. patent application Ser. No. 13/439,743 filed on Apr. 4, 2012, which in turn is a Continuation of U.S. patent application Ser. No. 12/854,849 filed on Aug. 11, 2010, all of which claim priority to U.S. Provisional Application No. 61/233,046 filed on Aug. 11, 2009, all of which are incorporated herein by reference.

The present application is also a Continuation-In-Part of U.S. patent application Ser. No. 13/464,269 filed on May 4, 2012, and is incorporated herein by reference.

### FIELD OF INVENTION

The present application relates generally to the field of computer technology and, in specific exemplary embodiments, to methods and systems for automatically and in realtime identifying subject matter categories for questions posted to an online consultation system, and extracting optional details embedded in the posted questions.

### BACKGROUND

In an online consultation system, users may submit questions related to one of hundreds of subject matter categories and sub-categories. The user posted questions need to be matched to the appropriate subject matter category, in order to presented to the right subject matter experts. In an exemplary online consultation system, where hundreds or thousands of questions are received every day, question categorization must happen automatically and based on question content. In certain embodiments of the online consultation system, the user may be asked to select a category to post his or her question to. However, many users may not be knowledgeable enough about the subject matter of their question to be able to correctly assign their question to one of tens of categories. This problem is even more acute if the less sophisticated user is asked to select a subcategory among tens of subcategories comprising a broad subject matter topic. Furthermore, the unsophisticated user may also lack enough understanding about the issue to know what details to furnish to help the subject matter expert respond to his or her question without too many back and forth communications.

In certain embodiments of an online consultation system, the question assignment may be done manually by category moderators. However, manual categorization is not an ideal implementation because in a successful online consultation system, thousands of questions may be posted every day and therefore manual categorization and detail extraction is not scalable or cost effective.

### BRIEF DESCRIPTION OF DRAWINGS

The appended drawings are merely used to illustrate exemplary embodiments of the present invention and cannot be considered as limiting its scope.

FIG. 1 shows an exemplary flowchart of a method of automatically categorizing and extracting question details.

FIG. 2 shows an exemplary flowchart of a method of automatically categorizing and extracting question details.

FIG. 3 illustrates an exemplary landing and optional details page illustrates.

FIG. 4 shows a simplified block diagram of a digital device within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on quality control of experts, the embodiments are given merely for clarity and disclosure. Alternative embodiments may employ other systems and methods and are considered as being within the scope of the present invention.

Embodiments of the present invention provide systems and methods for automatically assigning a category to each question that is posted to an exemplary online consultation system, and in real-time or on-the-fly extracting any optional details the user may be including in the body of his or her posted question. As previously mentioned.

In the exemplary online consultation system of the present invention, users post questions to the online consultation system with the hope of receiving high quality, reliable answers from subject matter experts. The posted questions have to be matched to the appropriate subject matter category as a prerequisite to being assigned to right subject matter experts. Additionally, the questions must include certain amount of details necessary for the subject matter expert to provide an appropriate answer to the user. Users may be asked to select a subject matter category for the question they are posting and manually enter the question details that are useful and sometimes necessary to receive an answer to the question. However, putting such a burden on the customer may not be desirable and may result in mis-categorization resulting in delay. Alternatively, the online consultation system may take on the task of manually categorizing the posted questions. However, in a successful online consultation system, thousands of questions may be posted every day. Therefore, manual question categorization and detail extraction has serious and practical limitations, is inefficient, and prone to mistakes and mis-categorizations which again would delay the provision of a timely response to the user's inquiry. It would therefore be highly desirable to provide a system and method that is capable of automatically categorizing or suggesting a category for the user posted questions, based on the content of the question as well identifying question details in real-time as the user is typing the text of the question, allowing the system to get confirmation from the user on the accuracy of the details entered.

Embodiments of the present invention provide for an intelligent engine capable of identifying and suggesting a topic category based on the content of the posted question. In alternative embodiments of the present invention, the systems and methods are described capable of extracting details from the relevant question content detail that may be useful or necessary for a subject matter expert to answer the question. In alternative embodiments of the present invention, system and methods are disclosed that allow the online consultation system to identify and suggest a subject matter category based on the user posted question and extract details from the question “on-the-fly”, as the user is typing his or her question in the question input field.

Embodiments of the present invention further provide system and methods are disclosed to dynamically pre-populate optional question detail fields with question details as the user is typing them.

in the case where the user has manually selected a subject matter category related to his or her question, embodiments of the present invention further provide, automated topic extraction which may be used to help users further refine their category selection by assigning their question to an appropriate subcategory suggested by the online consultation system. This would help the user select the most specific topic category and access the best subject matter experts that are the most knowledgeable about the subject of the question.

In order to illustrate various implementations of the present invention, an online consultation website will be used hereinafter as an example. It would be apparent to one of skill in the art that the teachings of the present invention are not limited to the examples used herein and the systems and methods of the present invention have broader applications.

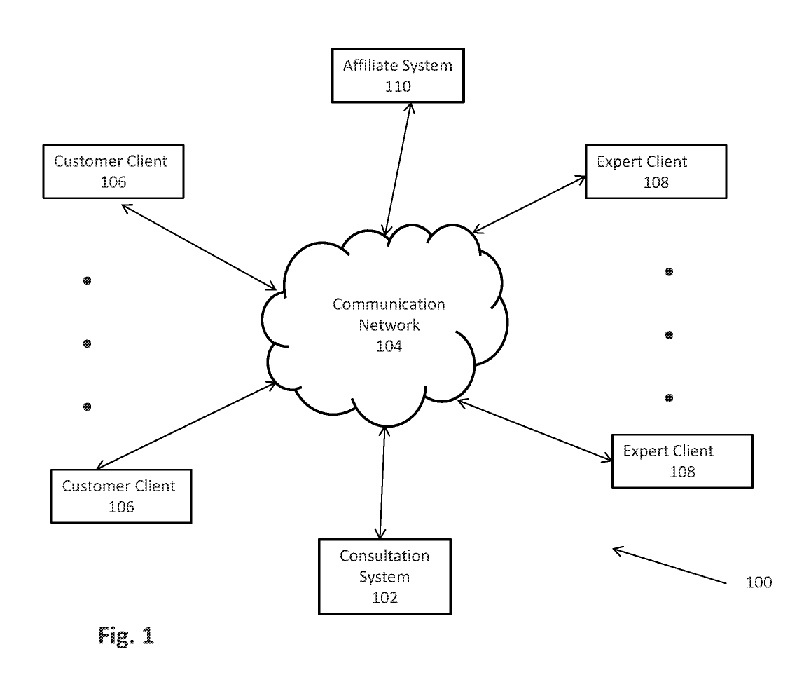

FIG. 1 shows an exemplary environment 100 of an online consultation website and system in which embodiments of the present invention may be practiced. The exemplary environment 100 comprises a consultation system 102 coupled via a communications network 104 to one or more customer clients 106, (also referred to as the user client 106 hereafter) and expert clients 108. The communication network 104 may comprise one or more local area networks or wide area networks such as, for example, the Internet and telephone systems.

In exemplary embodiments, the consultation system 102 provides a forum where users may post or pose questions for which experts may provide answers. The consultation system 102 may provide the forum via a website. In some embodiments, at least portions of the forum (e.g., asking of questions or receiving of responses) may occur via the website, mobile phone, other websites, text messaging, telephone, video, VoIP, or other computer software applications. Because the consultation system 102 is network based e.g., Internet, public switched telephone network (PSTN), cellular network, the users using the consultation system 102 and experts providing answers may be geographically dispersed (e.g., may be located anywhere in the world). As a result an expert may provide answers to a user thousands of miles away. Additionally, the consultation system 102 allows a large number of users and experts to exchange information at the same time and at any time.

By using embodiments of the present invention, a user posting a question may easily obtain a tailored answer. Accordingly, one or more of the methodologies discussed herein may obviate a need for additional searching for answers, which may have the technical effect of reducing computing resources used by one or more devices within the system. Examples of such computing resources include, without limitation, processor cycles, network traffic, memory usage, storage space, and power consumption.

In various embodiments, a user may pose a question and one or more experts may provide answers. In various embodiments, the question may be matched with a category of experts, more specific set of experts, or even individual experts, sometimes on a rotating basis by user selection, a keyword based algorithm, a quality based algorithm (or score or rating), or other sorting mechanism that may include considerations such as, for example, likely location or time zone. A back-and-forth communication can occur. Part of the back-and-forth communication may be the experts asking the users to supplement their question with necessary missing details that would help the expert provide a satisfactory answer. Embodiments of the present invention may eliminate the need for experts to have to spend time and effort to solicit from the users, missing question details. In various embodiment of the present invention, the consultation system 102 will automatically identify question details embedded in the submitted question and will attempt to either automatically confirm the embedded question details or solicit the details from the user in case the relevant details were not provided.

The user may accept an answer provided by one or more of the experts. In an alternative embodiment, the user may be deemed to have accepted the answer if the user does not reject it. By accepting the answer, the user validates the expert's answer which, in turn, may boost a score or rating associated with the expert. The user may also pay the expert for any accepted answers and may add a bonus. The user may also leave positive, neutral or negative feedback regarding the expert.

The exemplary user client 106 is a device associated with a user accessing the consultation system 102 (e.g., via a website, telephone number, text message identifier, or other contact means associated with the consultation system 102). The user may comprise any individual who has a question or is interested in finding answers to previously asked questions. The user client 106 comprises a computing device (e.g., laptop, PDA, cellular phone) which has communication network access ability. For example, the user client 106 may be a desktop computer initiating a browser for access to information on the communication network 104. The user client 106 may also be associated with other devices for communication such as a telephone.

In exemplary embodiments, the expert client 108 is a device associated with an expert. The expert, by definition, may be any person that has, or entity whose members have, knowledge and appropriate qualifications relating to a particular subject matter. Some examples of expert subject matters include health (e.g., dental), medical (e.g., eye or pediatrics), legal (e.g., employment, intellectual property, or personal injury law), car, tax, computer, electronics, parenting, relationships, and so forth. Almost any subject matter that may be of interest to a user for which an expert has knowledge and appropriate qualifications may be contemplated. The expert may, but does not necessarily need to, have a license, certification or degree in a particular subject matter. For example, a car expert may have practical experience working the past 20 years at a car repair shop. In some embodiments, the expert may be a user (e.g., the expert posts a question).

The expert client 108 may comprise a computing device (e.g., laptop, PDA, cellular phone) which has communication network access ability. For example, the expert client 108 may be a desktop computer initiating a browser to exchange information via, the communication network 104 with the consultation system 102. The expert client 108 may also be associated with other devices for communication such as a telephone.

In accordance with one embodiment, an affiliate system 110 may be provided in the exemplary environment 100. The affiliate system 110 may comprise an affiliate website or other portal which may include some of the components of the consultation system 102 or direct their users to the consultation system 102. For example, the affiliate system 110 may provide a website for a car group. A link or question box may be provided on the affiliate website to allow members of the car group to ask questions. The environment 100 of FIG. 1 is exemplary. Alternative embodiments may comprise any number of consultation systems 102, user clients 106, expert clients 108, and affiliate systems 110 coupled together via any type of one or more communication networks 104, and still be within the scope of exemplary embodiments of the present invention. For example, while only one consultation system 102 is shown in the environment 100, alternative embodiments may comprise more than one consultation system 102. For instance, the consultation systems 102 may be regionally established.

The U.S. patent application Ser. No. 13/464,269, entitled “Method And Apparatus For Identifying And Eliciting Missing Question Details In A Consultation System” is the parent application to the present application and describes in detail the system and methods for identifying missing details in questions posted by users to the exemplary online consultation system of the present invention. Embodiments of the present invention provide for system and methods that provide improvement over the parent application by providing the ability for on-the-fly question detail extraction and topic category suggestion.

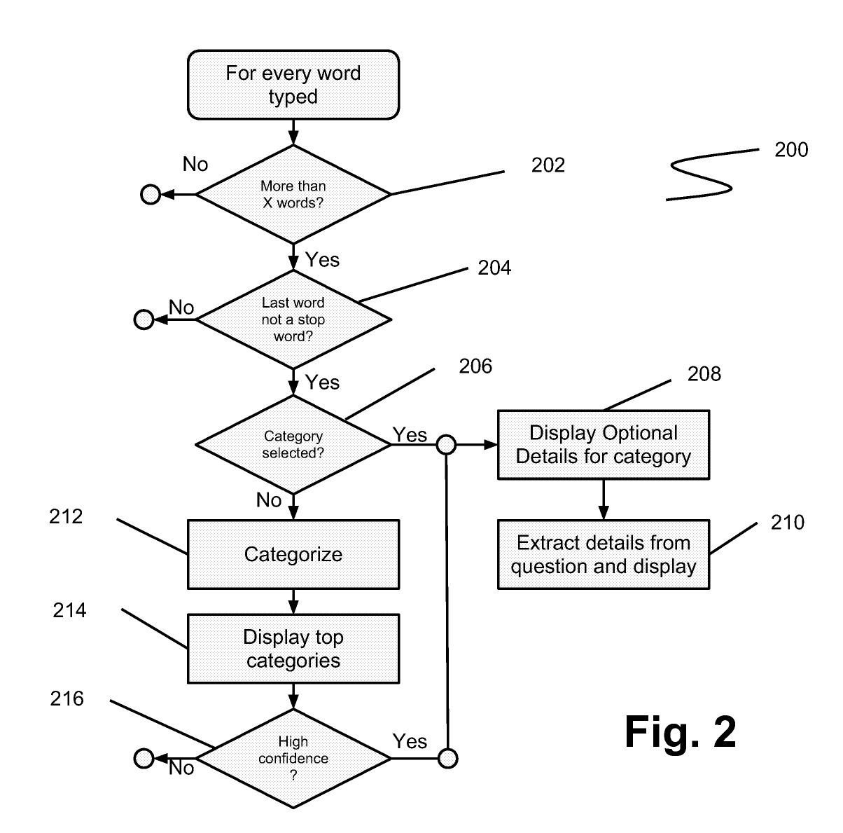

FIG. 2 shows an exemplary flowchart of a method of automatically categorizing and extracting question details as the user is entering his question. In the exemplary environment of the present invention. In operation 202, for every word the user types in a question input field, the system verifies whether more than an upper threshold “X” of words has been typed in. If more than X words were typed in by the user, in operation 204, the system checks to see if the last word typed is a stop word or not. If the last word is not a stop word, the process continues in operation 206, where the system verifies if a topic category has been selected by the user, corresponding to the question he or she has submitted. If a question category has been specified by the user, the process continues in operation 208. However, if a question category has not been specified by the user, the process continues in operation 212 with automated question categorization by the online consultation system 102, where the online consultation system suggests a category to the user based on the optional details extracted from the question content up to that point. In alternative embodiments of the present invention, even if the user has selected a subject matter category for the question he or she is inputting, the process may still apply by offering the user further refinement by providing sub-category suggestions.

Continuing on the path of user specified question category, in operation 208, the system displays the optional detail fields corresponding to the topic category selected by the user. In operation 210, the system extracts any question details from the question content and populates the corresponding optional detail fields. In alternative embodiments of the present invention, for each extracted optional detail, the system requires confirmation from the user that the extracted detail is accurately identified. In yet other alternative embodiments of the present invention, the user has the option but is not required to edit the extracted optional details. The question detail extraction is described in detail in the US patent application entitled “Method and Apparatus For Identifying And Eliciting Missing Question Details In A Consultation System,” which the parent application of the present application and is incorporated herein by reference.

If in operation 206, it is determined that the user has not specified a question category, in operation 212 the system will automatically identify and suggest possible subject matter categories, based on the content of the question typed in the question field.

In operation 214, the process continues by displaying to the user the top subject matter category matches. In one embodiment, the top categories are displayed to the user based on the confidence value associated with each category.

In operation 216, if the system cannot identify with high confidence (higher than a given threshold) at least one subject matter category corresponding to the topics present in the content of the user typed question, the system will not proceed further, or until further question content is inputted. Alternatively, if at least one subject matter category was identified with a confidence above a given threshold, the process implicitly selects the category and continues in operation 208 with the display of optional details related to the user posted question.

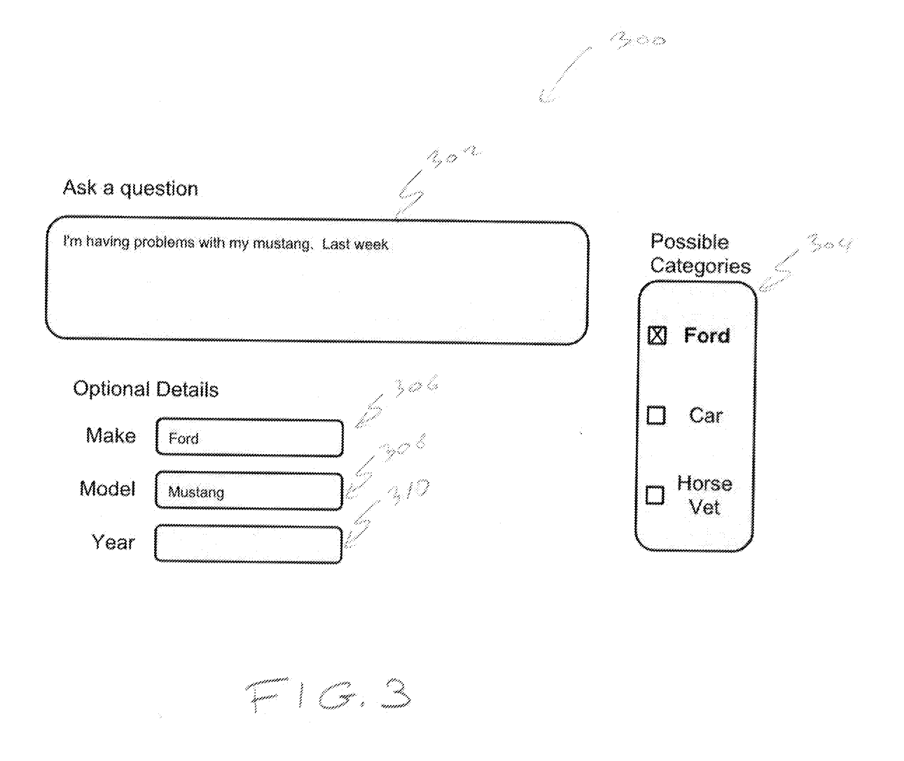

FIG. 3 illustrates an exemplary landing and optional details page 300. As seen in FIG. 3, the landing and optional detail page 300 includes a question entry field 302 entitled “Ask a question” where the user may post his or her question. A category selection field 302 entitled “possible categories” allows the user to select the subject matter category his or her question is related too. “Optional details” fields 306, 308 and 310 allow the user to provide details that may be helpful or necessary for a subject matter expert to provide an answer to the user's question. In exemplary embodiments of the present invention, the online consultation system 102 may automatically extract from the content of the question being typed, information to populate the “optional details” fields 306-310 and “possible categories” field when the user has not provided any optional details or selected a subject matter category explicitly. In exemplary embodiments of the present invention, the consultation system 102 only suggests optional details or category selection and asks the user for verification of the suggested information.

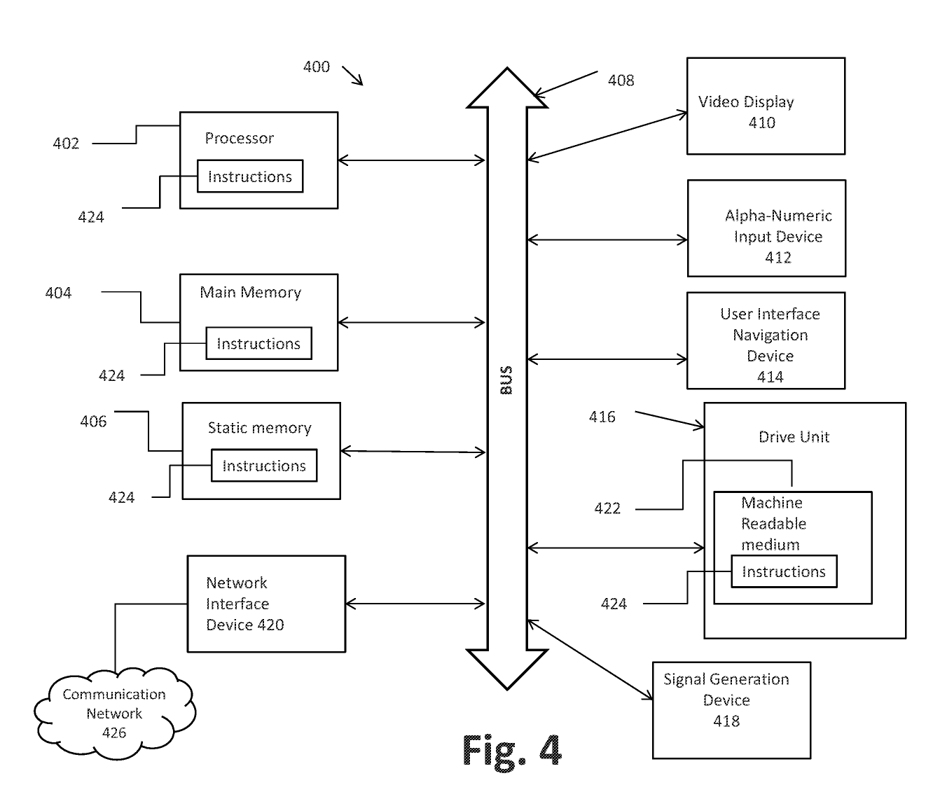

FIG. 4 a simplified block diagram of a digital device within which a set of instructions, for causing the machine to perform any one or more of the methodologies discussed herein, may be executed.

### Modules, Components, and Logic

Certain embodiments described herein may be implemented as logic or a number of modules, engines, components, or mechanisms, A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module or engine should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information),

### Exemplary Machine Architecture and Machine-Readable Medium

With reference to FIG. 4, an exemplary embodiment extends to a machine in the exemplary form of a computer system 400 within which instructions for causing the machine to perform any one or more of the methodologies discussed herein may be executed. In exemplary embodiments, the computer system 400 may be any one or more of the user client 106, the expert client 108, affiliate system 110, and servers of the consultation system 102. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 may include a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). In exemplary embodiments, the computer system 400 also includes one or more of an alpha-numeric input device 99 (e.g., a keyboard), a user interface (UI) navigation device or cursor control device 414 (e.g., a mouse), a disk drive unit 416, a signal generation device 418 (e.g., a speaker), and a network interface device 420.

### Machine-Readable Medium

The disk drive unit 416 includes a machine-readable medium 422 on which is stored one or more sets of instructions 424 and data structures (e.g., software instructions) embodying or used by any one or more of the methodologies or functions described herein. The instructions 424 may also reside, completely or at least partially, within the main memory 404 or within the processor 402 during execution thereof by the computer system 400, the main memory 404 and the processor 402 also constituting machine-readable media.

While the machine-readable medium 422 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. The term “machine-readable medium” shall also be taken to include any non-transitory storage medium.

### Transmission Medium

The instructions 424 may further be transmitted or received over a communications network 426 using a transmission medium via the network interface device 420 and utilizing any one of a number of well-known transfer protocols (e.g., HTTP). Examples of communication networks include a local area network (IAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A computer implemented method for real-time identification of question details and question categories, in a consultation system, the computer implemented method comprising:
for every word prior to a stop word entered by a user prior typing a question to be posted to a consultation system,
using at least one processor to:
read the next word entered by the user;
read a subject category selection from the user,
display optional details for the selected category, and
extract details from the words included in the posted question and present to the user the extracted details as category specific optional details suggestions.

2. The method of claim 1, wherein the optional detail extraction is further comprising:
parsing the question into phrasal components;
identifying a question detail by matching the question detail to a concept found in one or more ontologies corresponding to the selected category;
extracting most specific details found in the question as optional details within the posted question; and
populating a question detail field.

3. The method of claim 2, further comprising:
requesting from the user confirmation of the accuracy of the optional details.

4. The method of claim 1, further comprising:
suggesting a subject category for the posted question based on the optional details if the user has not selected the subject category;
receiving subject category verification from the user; and
presenting optional details to the user based on the category verification.

5. A non-transitory machine-readable storage medium having embodied thereon instructions which when executed by at least one processor, causes a machine to perform operations comprising:
for every word prior to a stop word entered by a user prior typing a question to be posted to a consultation system,
using at least one processor to:
read the next word entered by the user;
read a subject category selection from the user,
display optional details for the selected category, and
extract details from the words included the posted question and present to the user the extracted details as category specific optional details suggestions.
